(19) United States
(12) Patent Application Publication
(10) Pub. No.: US 2026/0087410 A1
(43) Pub. Date: Mar. 26, 2026

(54) PROCESSING METHOD

(71) Applicant: TOYOTA JIDOSHA KABUSHIKI KAISHA, Toyota-shi (JP)

(72) Inventor: Ryokichi ONISHI, Tokyo-to (JP)

(73) Assignee: TOYOTA JIDOSHA KABUSHIKI KAISHA, Toyota-shi (JP)

(21) Appl. No.: 19/313,126

(22) Filed: Aug. 28, 2025

(30) Foreign Application Priority Data
Sep. 24, 2024 (JP) 2024-165192

(51) Int. Cl. G06N 20/00

(52) U.S. Cl. CPC G06N 20/00

(57) ABSTRACT

A processing method includes steps of: acquiring job information about a job related to machine learning that is being performed at one of a plurality of nodes; identifying, based on the job information, another node of the plurality of nodes that enables a remaining part of the job to be completed within a learning deadline; comparing a first cost, which is a cost in a case where the job is continued at the one node, with a second cost, which is a cost in a case where the remaining part of the job is performed at the other node; and transferring the job from the one node to the other node, in a case where the second cost is less than the first cost.

### INCORPORATION BY REFERENCE

This application is based upon and claims the benefit of priority from Japanese Patent Application No. 2024-165192, filed on September 24, 2024, the disclosure of which is incorporated herein in its entirety by reference.

### TECHNICAL FIELD

Embodiments of the present disclosure relate to technical fields of a processing method, and more specifically, to a processing method that processes a job related to machine learning.

### BACKGROUND ART

Services using learned/trained models (i.e., AI (Artificial Intelligence)) generated by machine learning have been proposed. For example, JP2022-034850A as Patent Literature 1 describes a service that provides safe driving support information based on an output of a learned model, wherein types and installation environments of signs or markings around a vehicle, a driving status of the vehicle, a position of the vehicle, and a vehicle driver's line of sight direction are inputted into the learned model.

In the technique/technology described in Patent Literature 1, the learned model is used in an in-vehicle device, but the learned model may also be used in a data center with higher processing capacity than that of the in-vehicle device. For example, a service that provides the safe driving support information described in Patent Literature 1 requires real-time processing of a relatively small data amount from the vehicle. On the other hand, machine learning for generating a learning model requires processing of a large data amount. That is, a required performance of the data center to be used to provide the above service differs from a required performance of the data center to be used to perform machine learning. Incidentally, a learning model development cost often varies depending on the data center used to develop the learning model (in other words, in which machine learning is performed). If no measures are taken, the learning model development cost may increase, which is technically problematic.

### SUMMARY

In view of the above-described problems, it is an object of the present disclosure to provide a processing method that is allowed to select a data center such that a learning model development cost is reduced/controlled.

A processing method according to an aspect of the present disclosure includes steps of: acquiring job information about a job related to machine learning that is being performed at one of a plurality of nodes; identifying, based on the job information, another node of the plurality of nodes that enables a remaining part of the job to be completed within a learning deadline; comparing a first cost, which is a cost in a case where the job is continued at the one node, with a second cost, which is a cost in a case where the remaining part of the job is performed at the other node; and transferring the job from the one node to the other node, in a case where the second cost is less than the first cost.

### BRIEF DESCRIPTION OF THE DRAWINGS

FIG. 1 is a conceptual diagram illustrating a system according to an embodiment;

FIG. 2 is a block diagram illustrating a configuration of an information processing apparatus according to the embodiment;

FIG. 3 is a diagram illustrating an example of computing infrastructure information;

FIG. 4 is a diagram illustrating an example of job information;

FIG. 5 is a diagram illustrating an example of an image for inputting the job information;

FIG. 6 is a conceptual diagram illustrating an example of job processing according to the embodiment;

FIG. 7 is a flowchart illustrating an example of job processing according to the embodiment; and

FIG. 8 is a diagram illustrating an example of an image indicating a result of machine learning.

### EMBODIMENT

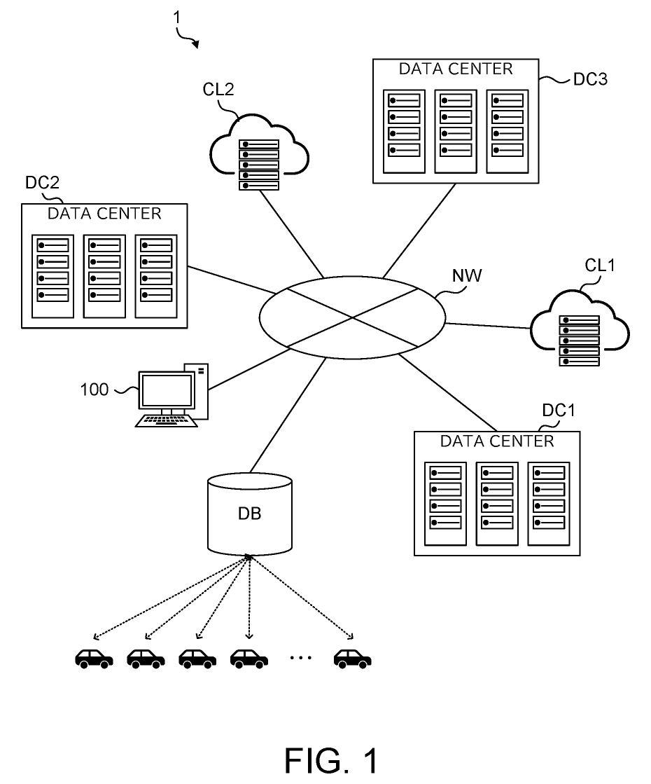

A processing method according to an embodiment will be described with reference to FIG. 1 to FIG. 8.

### System

The system according to the embodiment will be described with reference to FIG. 1. In FIG. 1, a system 1 includes data centers DC1, DC2, and DC3 connected to each other via a network NW, and clouds CL1 and CL2. The number of the data centers included in the system 1 may be two or less, or four or more. The number of the clouds included in the system 1 may be one, or three or more.

The locations of the data centers DC1, DC2, and DC3 may be arbitrary. For example, the data center DC1 may be located in Japan, the data center DC2 may be located in the United States, and the data center DC3 may be located in Europe. For example, the data center DC1 may be located in Aichi Prefecture, the data center DC2 may be located in Kyushu, and the data center DC3 may be located in Hokkaido.

At least one of the data centers DC1, DC2, and DC3 may be a container-type data center. At least a part of power supplies of the container-type data center may utilize used batteries from BEVs (Battery Electric Vehicles).

At least one of the data centers DC1, DC2, and DC3 may be a data center owned by an own company (i.e., an on-premises type data center). The data centers DC1, DC2, and DC3 may include a data center provided by another business operator (i.e., a hosted type data center). At least one of the clouds CL1 and CL2 may be a public cloud that shares an environment built by a cloud service provider with other users. The clouds CL1 and CL2 may include a hosted type private cloud in which a cloud environment provided by a cloud service provider is exclusively used by a specific user. Note that the hosted type data center and the hosted type private cloud may be considered to be the same concept.

The data centers DC1, DC2, and DC3, as well as the clouds CL1 and CL2, may be referred to as “nodes.” In addition, the network NW may be referred to as a “link.” Therefore, it can be said that the system 1 is a computing infrastructure including a plurality of nodes that are configured to communicate via the network NW.

The system 1 is provided with a database DB. The database DB includes learning data to be used for machine learning. The learning data included in the database DB may be learning data related to commercially available learning datasets. The learning data included in the database DB may be learning data based on data collected from a plurality of vehicles (e.g., connected cars).

In the system 1, machine learning using at least a part of the learning data included in the database DB may be performed in at least a part of the data centers DC1, DC2, and DC3, and the clouds CL1 and CL2.

### Configuration of Information Processing Apparatus

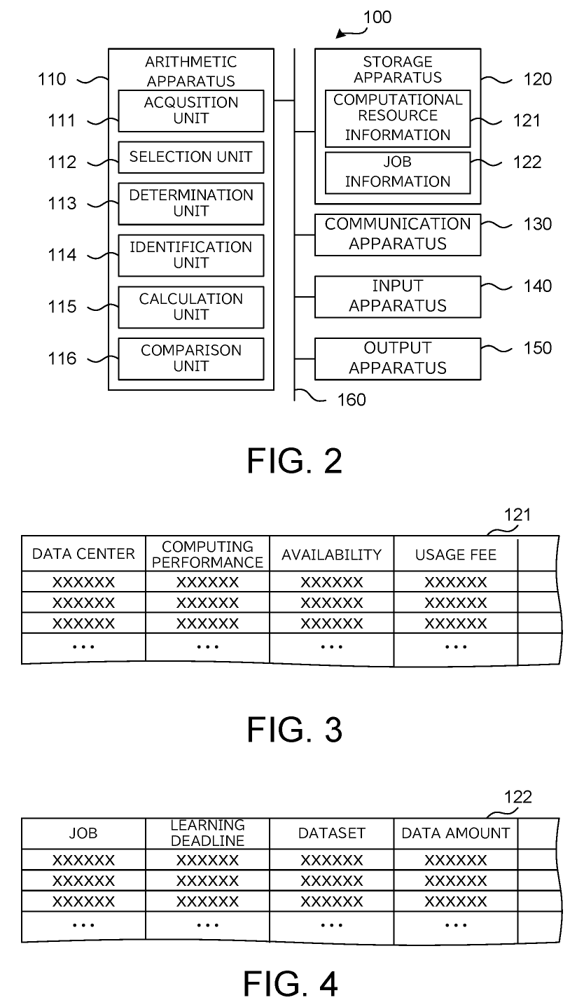

The system 1 is provided with an information processing apparatus 100. The information processing apparatus 100 will be described with reference to FIG. 2. In FIG. 2, the information processing apparatus 100 is provided with an arithmetic apparatus 110, a storage apparatus 120, a communication apparatus 130, an input apparatus 140, and an output apparatus 150. The arithmetic apparatus 110, the storage apparatus 120, the communication apparatus 130, the input apparatus 140, and the output apparatus 150 may be connected via a data bus 160.

The information processing apparatus 100 may not necessarily include at least one of the input apparatus 140 and the output apparatus 150. In this case, at least one of the input apparatus 140 and the output apparatus 150 may be connected to the information processing apparatus 100 via a not-illustrated input/output port of the information processing apparatus 100 (i.e., at least one of the input apparatus 140 and the output apparatus 150 may be attached externally to the information processing apparatus 100).

The arithmetic apparatus 110 may include one or more processors. The processor may be, for example, at least one of a CPU (central processing unit) and a GPU (graphics processing unit).

The storage apparatus 120 may include one or more memories. The memory may be, for example, at least one of a RAM (Random Access Memory), a ROM (Read Only Memory), a hard disk apparatus, a magneto-optical disk apparatus, and a SSD (Solid State Drive).

The communication apparatus 130 may be configured to communicate with an apparatus external to the information processing apparatus 100. The communication apparatus 130 may perform wired communication or wireless communication.

The input apparatus 140 is an apparatus that is configured to receive an input of information to the information processing apparatus 100 from the outside. The input apparatus 140 may include an operating apparatus (e.g., a keyboard, a mouse, a touch panel, etc.) that is operable by a user of the information processing apparatus 100. The input apparatus 140 may include a recording medium reading apparatus that is configured to read information recorded on a recording medium that is attachable to or detachable from the information processing apparatus 100, such as a USB (Universal Serial Bus) memory. In a case where information is inputted to the information processing apparatus 100 via the communication apparatus 130 (in other words, in a case where the information processing apparatus 100 acquires information via the communication apparatus 130), the communication apparatus 130 may function as an input apparatus.

The output apparatus 150 is an apparatus that is configured to output information to the outside of the information processing apparatus 100. The output apparatus 25 may output, as the above information, visual information such as characters and images, auditory information such as voice/sound, or tactile information such as vibration. The output apparatus 25 may include, for example, at least one of a display, a speaker, a printer, and a vibration motor. The output apparatus 25 may be configured to output information to a recording medium that is attachable to or detachable from the information processing apparatus 100 such as, for example, a USB memory. In a case where the information processing apparatus 100 outputs information via the communication apparatus 130, the communication apparatus 130 may function as an output apparatus.

The storage apparatus 120 is configured to store desired data. The storage apparatus 120 may store therein a computer program to be executed by the arithmetic apparatus 110. The storage apparatus 120 may temporarily store data that are temporarily used by the arithmetic apparatus 110 when the arithmetic apparatus 110 is executing the computer program.

The computer program may be recorded on a computer-readable and non-transitory recording medium. In this case, the information processing apparatus 100 may read the computer program from the above-mentioned recording medium, by using a not-illustrated recording medium reading apparatus. As a result, the computer program may be stored in the storage apparatus 120. At least one of an optical disk, a magnetic medium, a magneto-optical disk, a semiconductor memory, and any other medium configured to store a program may be used as the above-mentioned recording medium.

The computer program may be acquired from a not-illustrated apparatus external to the information processing apparatus 100 via the communication apparatus 130. That is, the information processing apparatus 100 may download the computer program via the communication apparatus 130. As a result, the computer program may be stored in the storage apparatus 120.

The arithmetic apparatus 110 may perform processing to be performed by the information processing apparatus 100, together with the storage apparatus 120 in which the computer program is stored. In other words, the arithmetic apparatus 110 may perform the processing to be performed by the information processing apparatus 100, together with the storage apparatus 120 and the computer program stored in the storage apparatus 120. For example, by the arithmetic apparatus 110 executing the computer program, logical function blocks for performing the processing to be performed by the information processing apparatus 100, may be realized in the arithmetic apparatus 110.

For example, the arithmetic apparatus 110 may include an acquisition unit 111, a selection unit 112, a determination unit 113, an identification unit 114, a calculation unit 115, and a comparison unit 116, as the above function blocks. The arithmetic apparatus 110 may include the acquisition unit 111, the selection unit 112, the determination unit 113, the identification unit 114, the calculation unit 115, and the comparison unit 116, as physically realized processing circuits. At least one of the acquisition unit 111, the selection unit 112, the determination unit 113, the identification unit 114, the calculation unit 115, and the comparison unit 116 may be realized in a mixed form of a logical function block and a physical processing circuit (i.e., hardware). The acquisition unit 111, the selection unit 112, the determination unit 113, the identification unit 114, the calculation unit 115, and the comparison unit 116 will be described in detail later.

The storage apparatus 120 stores therein computational resource information 121 and job information 122. The computational resource information 121 is information about a computational resource available for machine learning. For example, the computational resource information 121 may be information about each of the data centers DC1, DC2, and DC3, and the clouds CL1 and CL2. For example, as illustrated in FIG. 3, the computational resource information 121 may be information indicating computing performance, availability, and usage fee of each data center. For example, the data center may be represented by information for identifying the data center. For example, the computing performance may be represented by FLOPS (Floating-Point Operations Per Second). For example, the availability may be represented by the number of available cores.

The “data center” in FIG. 3 is not limited to the data centers DC1, DC2, and DC3, but conceptually includes the clouds CL1 and CL2. As described above, the data centers DC1, DC2, and DC3, as well as the clouds CL1 and CL2, may be referred to as “nodes.” Therefore, the computational resource information 121 may also be referred to as node information. Furthermore, the computational resource information 121 may include other items, in addition to “data center,” “computing performance,” “availability,” and “usage fee.”

The job information 122 is information about a job related to machine learning. For example, as illustrated in FIG. 4, the job information 122 may be information indicating a learning deadline, a dataset, and a data amount of each job. For example, the learning deadline may be a date indicating a learning deadline, or may be a period from the present to a learning deadline. For example, the dataset may be represented by information for identifying a dataset used for machine learning. For example, the data amount may be information indicating a data amount of the dataset. The job information 122 may include other items, in addition to “job,” “learning deadline,” “dataset,” and “data amount.”

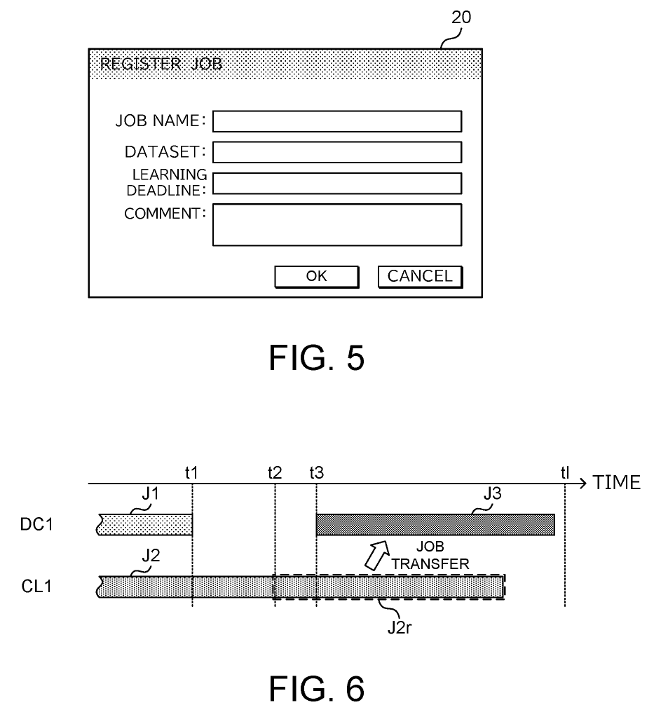

When the user of the information processing apparatus 100 registers a job, an image 20 illustrated in FIG. 5 may be displayed on a display serving as an example of the output apparatus 150. For example, the user may enter necessary information in at least one of a plurality of input fields included in the image 20 via the input apparatus 140. When the user presses an “OK” button included in the image 20 via the input apparatus 140, the information inputted by the user is registered in the job information 122.

For example, information entered in an input field related to “Job name” in the image 20 may be stored in a “Job” field of the job information 122. For example, information entered in an input field related to “Dataset” in the image 20 may be stored in a “Dataset” field of the job information 122. For example, information entered in an input field related to “Learning Deadline” in the image 20 may be stored in a “Learning Deadline” field of the job information 122. For example, the information processing apparatus 100 may identify the data amount of the dataset, based on the information entered in the input field related to “Dataset” in the image 20. The information processing apparatus 100 may store the identified data amount in a “Data amount” field of the job information 122.

### Operation of Information Processing Apparatus

The operation of the information processing apparatus 100 will be described. Explained first is processing in which the information processing apparatus 100 selects a data center that performs a job included in the job information 122 (i.e., a data center that performs machine learning corresponding to the job). Hereinafter, the “data center” is not limited to the data centers DC1, DC2, and DC3, but also conceptually includes the clouds CL1 and CL2.

The acquisition unit 111 of the arithmetic apparatus 110 acquires the data amount and the learning deadline related to one job included in the job information 122. The selection unit 112 of the arithmetic apparatus 110 may calculate the computing performance necessary to complete one job within the learning deadline, based on the acquired data amount and the acquired learning deadline.

The selection unit 112 may extract one or more data centers that are allowed to satisfy the calculated computing performance (in other words, that are allowed to complete one job within the learning deadline), based on the computational resource information 121. The selection unit 112 selects the data center that performs one job, from the extracted one or more data centers, such that the cost required for machine learning is reduced. The selection unit 112 may select one data center that performs machine learning corresponding to one job. The selection unit 112 may select a plurality of data centers that perform machine learning corresponding to one job. When the selection unit 112 selects a plurality of data centers, the determination unit 113 of the arithmetic apparatus 110 determines learning data to be inputted to each of the plurality of data centers, based on a dataset related to one job.

The selection unit 112 causes the selected data center to perform one job, via the communication apparatus 130. For example, the selection unit 112 may register one job in a queue related to the selected data center. At this time, the information processing apparatus 100 may transmit the dataset related to one job, to the selected data center from the database DB, based on the job information 122. When the selection unit 112 selects a plurality of data centers, the information processing apparatus 100 may transmit learning data related to one job, to each of the plurality of data centers from the database DB, based on a determination result by the determination unit 113. When the selection unit 112 selects the data center that performs one job, the selection unit 112 may register the data center that performs one job, in the job information 122.

Here, the usage fee of the data center varies for each data center. The usage fee is relatively low for the “on-premises type” and is relatively high for the “public cloud.” The usage fee of the “hosted type” is often higher than that of the “on-premises type” and is lower than that of the “public cloud.”

For example, in a case where the extracted one or more data centers described above include both the on-premises type and the public cloud, the selection unit 112 may select the on-premises type such that the cost required for machine learning is reduced. For example, in a case where the extracted one or more data centers described above include the hosted type and the public cloud, the selection unit 112 may select the hosted type such that the cost required for machine learning is reduced. In a case where the selection unit 112 selects a plurality of data centers that performs the machine learning corresponding to one job, the selection unit 112 may preferentially select the on-premises type such that the cost required for machine learning is reduced.

Explained next is processing in which the information processing apparatus 100 transfers a remaining part of one job included in job information 122, from one data center that performs the one job, to another data center.

As described above, the usage fee of the data center varies for each data center. For example, in a case where another data center with a lower usage fee than that of one data center that performs one job is available, a transfer of the remaining part of the one job from the one data center to the other data center, makes it possible to reduce the cost required for machine learning.

A concept of job transfer processing will be described with reference to FIG. 6. In FIG. 6, let us assume that the data center DC1 is an on-premises data center and the cloud CL1 is a public cloud. It is also assumed that the usage fee of the data center DC1 is cheaper than the usage fee of the cloud CL1.

At a time point when the information processing apparatus 100 selects a data center that performs a job J2, the data center DC1 is assumed to be performing a job J1. For this reason, the information processing apparatus 100 is assumed to select the cloud CL1, which is different from the data center DC1, as the data center that performs the job J2.

The job J1 is completed at a time t1 in FIG. 6. As a result, the data center DC1 is allowed to perform another job. In a period from the time t1 to a time t2 in FIG. 6, the information processing apparatus 100 may determine whether or not to transfer a job J2r, which is a part of the job J2 in the cloud CL1 after the time t2, to the data center DC1. For example, the information processing apparatus 100 may determine whether or not the data center DC1 enables the job J2r to be completed within the learning deadline, based on the data amount of data used in the job J2r, a time required to transmit the data to the data center DC1, and the learning deadline related to the job J2. The time tl in FIG. 6 corresponds to an example of the learning deadline related to the job J2.

When it is determined that the data center DC1 enables the job J2r to be completed within the learning deadline, the information processing apparatus 100 may transfer the job J2r to the data center DC1. In this case, the information processing apparatus 100 may transmit, to the cloud CL1, information indicating that the job J2 is to be completed at the time t2. The information processing apparatus 100 may register a job J3 corresponding to the job J2r, in a queue related to the data center DC1. As a result, from a time t3 in FIG. 6, the data center DC1 may perform machine learning corresponding to the job J3.

An initial value of a parameter of a learning model related to machine learning corresponding to the job J3 may be a value of a parameter at the time t2 of a learning model related to machine learning corresponding to the job J2. Furthermore, in at least a part of a period from the time t2 to the time t3 in FIG. 6, data used in the job J2r are transmitted to the data center DC1. Here, the data used in the job J2r may be transmitted from the cloud CL1 to the data center DC1, or from the database DB to the data center DC1. Furthermore, CRIU (Checkpoint/Restore in User Space) may be used for the job transfer described above.

For example, the usage fee of the cloud CL1 may be 10 US dollars per 10% of the job J2. For example, the usage fee of the data center DC1 may be 5 US dollars per 10% of the job J2. In a case where the cloud CL1 performs the entire job J2, a cost required to perform the job J2 is 100 US dollars.

For example, at the time t2 in FIGS. 6, 50% of the job J2 may be performed. In this case, the job J2r corresponds to 50% of the job J2. As illustrated in FIG. 6, in a case where the Job J2r is transferred to the data center DC1 as the job J3, the data center DC1 performs 50% of the job J2. That is, the cloud CL1 performs 50% of the job J2, and the data center DC1 performs the remaining 50% of the job J2. In this case, the cost required to perform the job J2 is 75 US dollars. As described above, the job transfer makes it possible to reduce the cost required to perform the job (in other words, the cost required for machine learning).

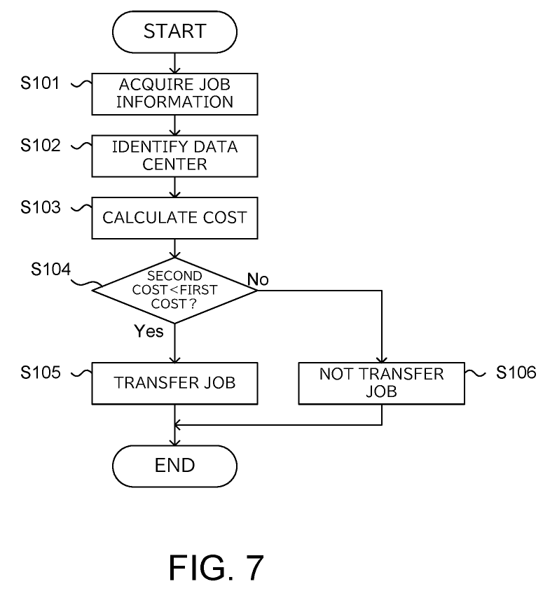

The job transfer processing will be described with reference to a flowchart in FIG. 7. In FIG. 7, the acquisition unit 111 of the information processing apparatus 100 may acquire one job that is being performed at one data center with a relatively high usage fee, from the job information 122 (step S101). For example, in the step S101, the acquisition unit 111 may acquire a job with a low progress rate, as the above-mentioned one job. This is because the job transfer is expected to have a significant cost-reducing effect.

Then, the identification unit 114 of the information processing apparatus 100 may acquire the learning deadline related to one job described above, from the job information 122. The identification unit 114 may estimate the data amount of data to be used for the remaining part of one job described above, based on the job information 122. The identification unit 114 may calculate a data transfer time, which is a time required to transfer the data, based on the estimated data amount. The identification unit 114 may calculate the computing performance necessary to complete the remaining part of one job within the learning deadline, based on the learning deadline related to the one job, the estimated data amount, and the calculated data transfer time. The identification unit 114 may identify another data center that is allowed to satisfy the calculated computing performance (in other words, that is allowed to complete the remaining part of one job within the learning deadline), based on the computing resource information 121 (step S102). That is, it can be said that the identification unit 114 identifies another data center, based on a time required to perform the remaining part of one job and the data transfer time. The identification unit 114 may identify a plurality of data centers, as another data center.

Then, the calculation unit 115 of the information processing apparatus 100 may calculate a first cost and a second cost (step S103). Here, the first cost is a cost when one job is continued at one data center that is currently performing the one job (e.g., when the entire one job is performed at one data center that is currently performing the one job). The second cost is a cost when the remaining part of one job is performed at another data center that is identified by the identification unit 114. The second cost may be the sum of a cost for performing the remaining part of one job at another data center and a cost for transferring data used for the remaining part of one job. In a case where the identification unit 114 identifies a plurality of other data centers, the calculation unit 115 may calculate the second cost for each of the plurality of other data centers.

Here, a description will be given of the cost for transferring the data used for the remaining part of one job. For example, costs are often incurred when data are extracted from a public cloud. Therefore, in a case where the above-described one data center is a public cloud, the cost for transferring the data may be the sum of a cost for extracting the data used for the remaining part of one job from the one data center and a communication cost for transmitting the data to another data center described above. In a case where there is no cost for extracting data from one data center, the cost for transferring the data may be equal to the communication cost for transmitting the data used for the remaining part of one job to another data center described above.

Then, the comparison unit 116 of the information processing apparatus 100 may compare the first cost with the second cost. The comparison unit 116 may determine whether or not the second cost is less than the first cost (step S104). In the step S106, when it is determined that the second cost is less than the first cost (the step S104: Yes), the information processing apparatus 100 may transfer one job from the data center that is currently performing the one job to another data center (step S105). In the step S106, when it is determined that the second cost is not less than the first cost (the step S104: No), the one data center may continue to perform the one job (i.e., one job may not be transferred) (step S106).

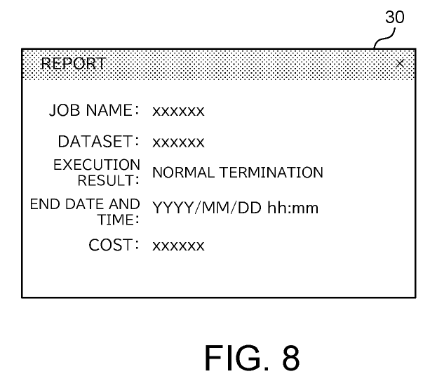

When the machine learning corresponding to one job is completed, the information processing apparatus 100 may acquire result information indicating a result of one job from the data center. The information processing apparatus 100 may store the result information in the storage apparatus 120. A user of the information processing apparatus 100 may cause the information processing apparatus 100 to display the result information via the input apparatus 140. In this case, the information processing apparatus 100 may display an image 30 illustrated in FIG. 8, on a display serving as an example of the output apparatus 150.

The job transfer may be performed not only once, but also multiple times. For example, a job that is being performed on a public cloud may be transferred to a hosted private cloud, and then further transferred from the hosted private cloud to an on-premises data center. The job transfer may be performed not only between data centers of different types, but also between data centers of the same type. For example, a job that is being performed on a public cloud with a relatively high usage fee may be transferred to a public cloud with a relatively low usage fee.

For example, data transfer associated with the job transfer may employ a technique/technology such as Linux Container, which transfers data required to perform a job (e.g., at least one of applications, libraries, dependencies, and files) all together. As described above, costs may be incurred when data are extracted from a data center (e.g., a public cloud). When one job that is being performed at one data center is transferred to another data center, a part of data about the one job (e.g., learning data) may be deleted from the one data center after the execution of the one job is stopped and before the data is transferred to the other data center. With this configuration, it is possible to reduce the amount of data extracted from the one data center due to the job transfer. That is, it is possible to reduce the cost for extracting data from one data center. In this case, the data deleted from the one data center may be transmitted, for example, from the database DB to another data center. In this case, the data extracted from the one data center (i.e., the data transferred from the one data center to another data center) may include metadata about the deleted data.

### Application Example

A learned/trained model generated by machine learning using the above-described system 1 may be applied, for example, to an advanced drive assistance function (Advanced Drive/Advanced Drive Assistance System).

For example, a base model related to the advanced drive assistance function may be generated, as the learned model, by machine learning using the system 1 and commercially available learning datasets included in the database DB. Furthermore, the base model may be fine-tuned by machine learning using the system 1 and learning data that are based on data collected from a plurality of vehicles traveling in a specific region and that are included in the database DB. As a result, a learning model related to the advanced drive assistance function optimized for the specific region may be generated. Note that LORA (Low-Rank Adaptation) may be used for fine-tuning.

### Technical Effect

AI may be utilized to provide a safer and more comfortable driving environment for vehicles. For example, operational support of peripheral devices such as air conditioner and an audio system, support for safer driving, or the like, may be realized by executing the learned model (i.e., AI) related to the advanced drive assistance function on an in-vehicle device. By executing a learning model related to the advanced drive assistance function, on a server on a network, in addition to or instead of the in-vehicle device, more enhanced services may be provided to a vehicle user, via the communication apparatus mounted on a vehicle. A server that provides such services needs to respond in real time to a user’s requests. However, it is only a relatively small amount of data that are inputted to the server.

For example, in order to develop the AI related to the advanced drive assistance function, a server that performs machine learning (corresponding to a server included in the aforementioned data center) needs to process a large amount of data. However, real-time response is not required in case of sticking to a predetermined development schedule. In other words, a processing time may not necessarily be short in case of sticking to the predetermined development schedule. Thus, the server that executes the learned model and the server that performs machine learning are required to have different performances.

As described above, the usage fee often varies depending on the data center. In the system 1 according to the present embodiment, the information processing apparatus 100 selects the data center such that machine learning is completed within the learning deadline and such that the cost required for machine learning is reduced. In the system 1 according to the present embodiment, the information processing apparatus 100 may furthermore transfer a job that is being performed at one data center, to another data center such that the cost required for machine learning is reduced. That is, in the system 1, the data center is selected such that the cost required for machine learning is reduced, while sticking to a predetermined development schedule. Therefore, according to the system 1 in the present embodiment, it is possible to select the data center such that a learning model development cost is reduced/controlled.

The system 1 may include an on-premises type data center that satisfies a stable computing demand of an own company and at least one of a hosted type private cloud and a public cloud that satisfies the remaining computing demand of the own company. The information processing apparatus 100 may select the data center such that machine learning is completed within the learning deadline and such that the cost required for machine learning is reduced. With this configuration, it is possible to reduce/control the learning model development cost, while satisfying the computing demand of the own company.

### First Modified Example

The computational resource information 121 may further include environmental impact information indicating an environmental impact related to the data center. For example, the environmental impact information may include an index indicating the environmental impact. For example, the environmental impact information may include information indicating a type of energy used by the data center. The type of energy may include, for example, green energy, renewable energy, fossil energy, and the like.

For example, the calculation unit 115 of the information processing apparatus 100 may calculate the first cost and the second cost, based on the environmental impact information included in the computing resource information 121. In this case, the first cost may include a first environmental impact cost related to an environmental impact of one data center that is currently performing one job. The second cost may include a second environmental impact cost related to an environmental impact of another data center that is identified by the identification unit 114. For example, the environmental impact cost may be a cost for reducing the environmental impact caused by the data center. In this case, the environmental impact cost of a data center using fossil energy may be higher than that of a data center using green energy. With this configuration, it is possible to reduce the environmental impact, while reducing the learning model development cost.

### Second Modified Example

The computational resource information 121 may further include the environmental impact information indicating the environmental impact related to the data center and power information about a power supply situation in an area including the data center. The power information may include, for example, an amount of power generated by solar power generation, an amount of power generated by wind power generation, an amount of power stored in storage batteries, presence/absence of output suppression, and the like.

The calculation unit 115 of the information processing apparatus 100 may calculate a first score and a second score, instead of the first cost and the second cost. The first score is a score when one job is continued at one data center that is currently performing the one job (e.g., when the entire one job is performed at one data center that is currently performing the one job). The second score is a score when the remaining part of one job is performed at another data center that is identified by the identification unit 114. The first score and the second score may be calculated based on a monetary score related to the usage fee, an environmental score related to the environmental impact, and a power score related to the power supply situation. Here, the monetary score may be smaller as the usage fee of the data center is lower. The environmental score may be smaller as the environmental impact of the data center is lower. The power score may be smaller as a power supply capacity is larger in the area including the data center.

For example, the calculation unit 115 may calculate the first score as “w1×(first monetary score) + w2×(first environmental score) + w3×(first power score).” Here, the first monetary score, the first environmental score, and the first power score refer to a monetary score, an environmental score, and a power score associated with one data center, respectively. The calculation unit 115 may calculate the second score as “w1×(second monetary score) + w2×(second environmental score) + w3×(second power score).” Here, the second monetary score, the second environmental score, and the second power score refer to a monetary score, an environmental score, and a power score associated with another data center, respectively. Additionally, “w1,” “w2,” and “w3” are weights. The weight w1 is greater than the weights w2 and w3. A size relationship of the weights w2 and w3 may be determined according to a user's policy.

The comparison unit 116 of the information processing apparatus 100 may compare the first score with the second score. When the second score is smaller than the first score, the information processing apparatus 100 may transfer one job from the data center that is currently performing the one job to another data center. When the second score is not smaller than the first score, the one data center may continue to perform the one job (i.e., the one job may not be transferred).

For example, the amount of power generated by solar power generation and wind power generation is easily affected by weather conditions. When the amount of power generated by at least one of solar power generation and wind power generation exceeds a usage amount, at least one of solar power generation and wind power generation is temporarily stopped. That is, there are cases where solar power generation and wind power generation cannot be fully utilized. The data center consumes a relatively large amount of electricity. For this reason, an opportunity to use solar power generation and wind power generation is expected to increase, in a case where a data center in a region with a relatively large power supply capacity is utilized.

Therefore, by determining whether or not the job is transferred based on the first score and the second score, it is possible to reduce the environmental impact while reducing the learning model development cost. In addition, by transferring the job to the data center in the region with a relatively large power supply capacity, it is possible to prevent at least one of solar power generation and wind power generation from being temporarily stopped.

Aspects of the present disclosure derived from the embodiment and modified examples described above will be described below.

A processing method according to an aspect of the present disclosure includes steps of: acquiring job information about a job related to machine learning that is being performed at one of a plurality of nodes; identifying, based on the job information, another node of the plurality of nodes that enables a remaining part of the job to be completed within a learning deadline; comparing a first cost, which is a cost in a case where the job is continued at the one node, with a second cost, which is a cost in a case where the remaining part of the job is performed at the other node; and transferring the job from the one node to the other node, in a case where the second cost is less than the first cost. In the above embodiment, “the data centers DC1, DC2, and DC3, and the clouds CL1 and CL2” correspond to an example of the “nodes.”

In an example of the processing method, in the identifying step, the other node may be identified based on a time required to perform the remaining part of the job calculated based on the job information and a time required to transfer data used to perform the remaining part of the job. In this example, the second cost may be a sum of a cost for performing the remaining part of the job and a cost for transferring the data.

In another example of the processing method, the first cost may include a first environmental impact cost related to an environmental impact of the one node, and the second cost may include a second environmental impact cost related to an environmental impact of the other node.

In another example of the processing method, in the comparing step, a first score, which is a score when the job is continued at the one node, instead of the first cost, may be compared with a second score, which is a score when the remaining part of the job is performed at the other node, instead of the second cost, in the transferring step, the job may be transferred from the one node to the other node in a case where the second score is smaller than the first score, the first score may be calculated based on a monetary score, an environmental impact score, and a power score related to the one node, and the second score may be calculated based on a monetary score, an environmental impact score, and a power score related to the other node.

In another example of the processing method, the processing method may further include a step of outputting a report on the job, in response to completion of the job, wherein the report may include information about a cost.

In an example of the processing method, the plurality of nodes may include at least two of on-premises, a private cloud, and a public cloud.

A system according to an aspect of the present disclosure is a system that controls machine learning of a model in a computing infrastructure including a plurality of nodes that are configured to communicate via a network, the system including: an acquisition unit that acquires job information about a job related to machine learning that is being performed at one of a plurality of nodes; an identification unit that identifies, based on the job information, another node of the plurality of nodes that enables a remaining part of the job to be completed within a learning deadline; and a comparison unit that compares a first cost, which is a cost in a case where the job is continued at the one node, with a second cost, which is a cost in a case where the remaining part of the job is performed at the other node, wherein the job is transferred from the one node to the other node, in a case where the second cost is less than the first cost.

The present disclosure is not limited to the above-described examples and is allowed to be changed, if desired, without departing from the essence or spirit of the invention which can be read from the claims and the entire specification. A processing method with such changes is also included in the technical concepts of the present disclosure.

### DESCRIPTION OF REFERENCE NUMERALS

1: System, 100: Information processing apparatus, 111: Acquisition unit, 112: Selection unit, 113: Determination unit, DB: Database, DC1, DC2, DC3: Data center, CL1, CL2: Cloud, NW: Network

What is claimed is:

1. A processing method comprising steps of:
acquiring job information about a job related to machine learning that is being performed at one of a plurality of nodes;
identifying, based on the job information, another node of the plurality of nodes that enables a remaining part of the job to be completed within a learning deadline;
comparing a first cost, which is a cost in a case where the job is continued at the one node, with a second cost, which is a cost in a case where the remaining part of the job is performed at the other node; and
transferring the job from the one node to the other node, in a case where the second cost is less than the first cost.

2. The processing method according to claim 1, wherein in the identifying step, the other node is identified based on a time required to perform the remaining part of the job calculated based on the job information and a time required to transfer data used to perform the remaining part of the job.

3. The processing method according to claim 1, wherein the second cost is a sum of a cost for performing the remaining part of the job and a cost for transferring the data.

4. The processing method according to claim 1, wherein
the first cost includes a first environmental impact cost related to an environmental impact of the one node, and
the second cost includes a second environmental impact cost related to an environmental impact of the other node.

5. The processing method according to claim 1, wherein
in the comparing step, a first score, which is a score when the job is continued at the one node, instead of the first cost, is compared with a second score, which is a score when the remaining part of the job is performed at the other node, instead of the second cost,
in the transferring step, the job is transferred from the one node to the other node in a case where the second score is smaller than the first score,
the first score is calculated based on a monetary score, an environmental impact score, and a power score related to the one node, and
the second score is calculated based on a monetary score, an environmental impact score, and a power score related to the other node.

6. The processing method according to claim 1, further comprising a step of outputting a report on the job, in response to completion of the job, wherein
the report includes information about a cost.

7. The processing method according to claim 1, wherein the plurality of nodes include at least two of on-premises, a private cloud, and a public cloud.
